(19) United States
(12) Patent Application Publication
(10) Pub. No.: US 2006/0077833 A1
(43) Pub. Date: Apr. 13, 2006

(54) CONTROL SYSTEM FOR A DISK DEVICE

(76) Inventors: Hung-Yi Cheng, Tao-Yuan Hsien (TW); Wen-Kuan Peng, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/162,610

(22) Filed: Sep. 16, 2005

(30) Foreign Application Priority Data
Sep. 27, 2004 (TW) 093129376

(51) Int. Cl. G11B 7/00

(52) U.S. Cl. 369/47.36; 369/47.1; 369/53.22; 369/53.25

(57) ABSTRACT

A control system for a disk device is integrated into the control unit of a host. The control unit transmits a control signals to the control system. The control system transfers the control signals to a signal transferor, and outputs information signal to the control unit. By receiving the control signal from the signal transferor, a spindle motor rotates an optical disk, a pick-up head picks up information signals on the optical disk to the signal transfer, and a feeding mechanism moves the pick-up head backward and forward along the radial direction of the optical disk. The disk device is just used for igniting, transferring, and transmitting signals, and the high efficient control unit of the host directly controls the operation of the disk device to extend usage scope.

### BACKGROUND OF THE INVENTION

1. Field of the Invention

The present invention relates to a disk device, and more particularly to a control system of the disk device, which is integrated into a control unit of a host connected with the disk device for reducing its control complexity.

2. Description of the Prior Art

Due to the prompt development of the multimedia technology, as well as features of an optical disc having large memory capacity and easy data storage, the disk device becomes necessaries of various multimedia products. However, the disk device is still subjected to different brand's control chips with unlike specifications and functions, and can't speed up the exploitation and production.

Referring to FIG. 1, a prior disk device 10 mainly includes a casing 11 and a tray 12. The tray 12 having a claming mechanism 13 to fasten an optical disc 14 slides into or out of the casing 11 freely. When the tray 12 enters the casing 11 and reaches the play position, a pick-up head 15 controlled by the control system of the disk device 10 reads data on the optical disc 14 to pick up data, and the data are transmitted to a circuit board 17 disposed at the back end of the casing 11 through a cable 16. A control chip 18 on the circuit board 17 decodes the data to generate digital signals, and digital signals is transmitted to a host 20 connected with the disk device 10. By means of the highly efficient CPU 21 in the host 20, digital signals are transformed into video formats, such as MEEG1, MPEG2, JPEG, and BMP, or audio formats, such as CDA, WMA, WAV, and MP3, to play video or audio with peripherals, such as speakers and a screen.

The prior disk device 10 has a control system, as shown in FIG. 2. The control chip 18 of the control system includes a plurality of servo units. A motor servo unit 181 outputs signals to control a spindle motor 19 for rotating the optical disc 14 fixed by the claming mechanism 13. A laser servo unit 182 controls a laser diode 151 disposed in the pick-up head 15 to radiate a beam with proper power. A focusing servo unit 183 adjusts the focus of the pick-up head 15, and focuses the beam on the optical disc 14. Then, a feeding servo unit 184 controls a feeding mechanism 152 to move along the radial of the optical disc 14 for searching data. A tracking servo 185 adjusts the pick-up head 15 to move following the data trace on the optical disc 14. The beam is reflected back to the pick-up head 15 by the optical disc 14, and an optical transducer 151 receives the reflection of the beam to form an electric signal correspondent with different reflection flux. Then, the signal is decoded by a decoder unit 186 into a digital signal to output to the host 20, and reading the data is completed. Besides, during the control process reading the data in the disk device 10, some error messages caused by dust and the defect of the optical disc 14 is also judged and corrected by the control chip.

Hence, the speed, smooth, and quality of reading data on the optical disc 14 depend on the precise control operation of the control chip in the disk device 10. However, the various brand's control chips have their own specific standards, control manners and features. For the limitation of resources, one disk device manufacturer has to choice one or two kinds of control chips to design, and can hardly cover full-sized control chips. Meanwhile, those control chips are incompatible, and can not be substituted each other to cause the monopolization of key control chips. Even the disk device 10 is enforced to renew the design due to the lack of key control chips, and the period of the product exploitation and validation will be increased. Furthermore, the disk device needs to be adjusted based on the feature of the connective host, and the time of the integration between the disk device and the host is also increased. Therefore, considering different hosts, such as a computer or a video player, the disk device can't be substituted anytime. Thus, there are not only inconvenient, but reducing the mass production efficiency.

Besides, the room in the casing 11 of the optical disc, especially in a slim optical disk drive, is so finite not to easily change the circuit board 17 in response to the consumer trend for adding new functions, such as MEPG interface. Therefore, the prior disk device still has some defects to improve.

### SUMMARY OF THE INVENTION

It is an object of the invention to provide a control system for a disk device which enables the disk device only to ignite, transfer, and transmit signals for being substituted whenever. The adoptable range of the disk device is enlarged.

It is another object of the invention to provide a control system for a disk device which is directly controlled by a highly efficient control unit of a host to reduce component cost and curtail exploitation time of the disk device.

It is a further object of the invention to provide a control system for a disk device which, by means of removing the control component, simplifies the control and manufacture of the disk device, reduces the weight of the disk device, and increases flexible usage inside the disk device.

For achieving the above objects, the present invention is a control system for a disk device which is integrated into the control unit of a host. The control unit transmits a control signals to the control system. The control system transfers the control signals to a signal transferor, and outputs information signal to the control unit. By receiving the control signal from the signal transferor, a spindle motor rotates an optical disk, a pick-up head picks up information signals on the optical disk to the signal transfer, and a feeding mechanism moves the pick-up head backward and forward along the radial direction of the optical disk. The disk device is just used for igniting, transferring, and transmitting signals, and the high efficient control unit of the host directly controls the operation of the disk device to extend usage scope.

### BRIEF DESCRIPTION OF THE DRAWINGS

FIG. 1 is a top view of the prior disk device.

FIG. 2 is a block diagram of the prior disk device.

FIG. 3 is a block diagram of the invention.

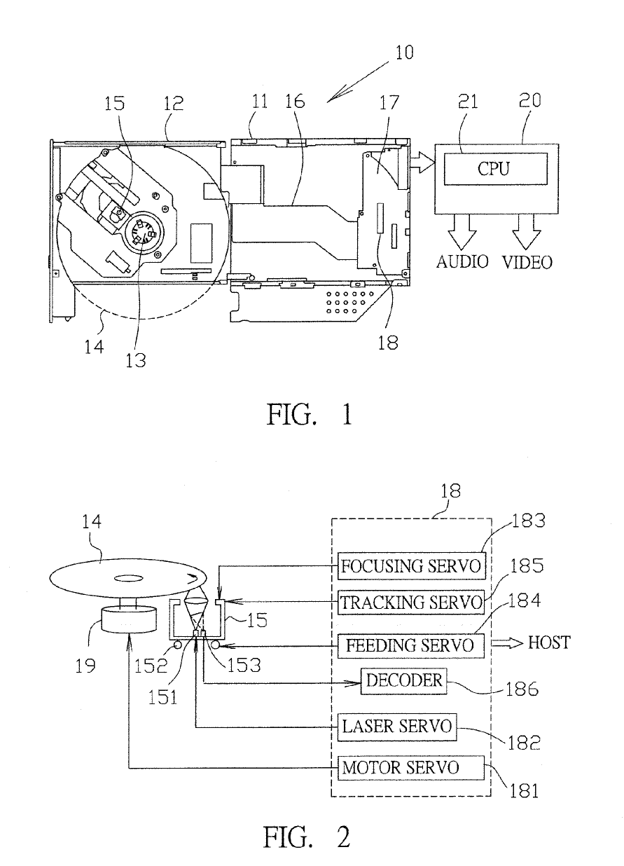

### DETAILED DESCRIPTION

Other objects, features, and advantages of the invention will become apparent from the following detailed description of the preferred but non-limiting embodiments. The following description is made with reference to the accompanying drawings. Anyone who is skilled in related technology would be able to understand and implement the technology accordingly.

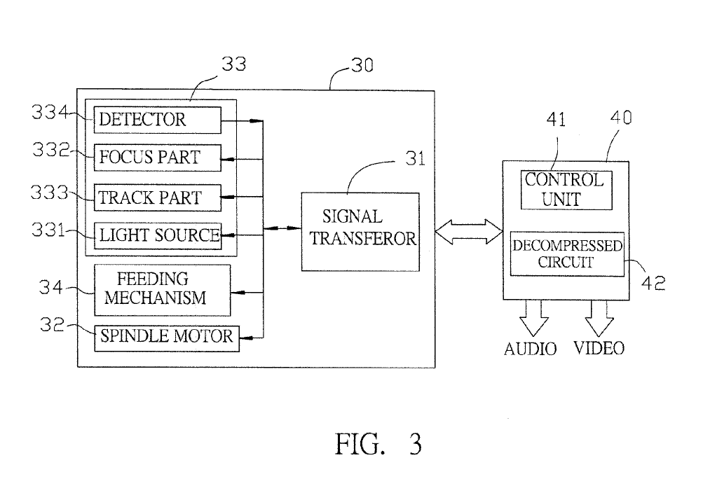

Referring to FIG. 3, the embodiment of the invention shows a control system 30 which includes a signal transferor 31, a spindle motor 32, a pick-up head 33, and a feeding mechanism 34. The signal transferor 31 is used to receive the outer control signals to control the spindle motor 32 for rotating an optical disk (not shown) and control the feeding mechanism 34 for moving the pick-up head 33 to read the information data on the optical disk, and the information data are transmitted back to he signal transferor 31 for outputting.

The signal transferor 31 is an interface of signal receiving and outputting. The signal transferor 31 just takes charge of changing signals of the control system 30 of a disk device with outer devices, and doesn't process the signals. By transmitting control signals through the signal transferor 31 to the spindle motor 32, the pick-up head 33, and the feeding mechanism 34, the control signals directly ignite and control those apparatuses. The feeding mechanism 34, a linear moving mechanism, is controlled by the control signal from the signal transferor 31 to move the pick-up head 33 back and forth along the radial of the optical disk.

Besides, the pick-up head 33 further includes a light source part 331, a focus part 332, a track part 333, and a detector 334. The light source part 331, such as a laser diode, is controlled by the control signal from the signal transferor 31 to radiate a beam with proper power. The focus part 332 is controlled by the control signal from the signal transferor 31 to project and focus the beam for forming a focusing spot suitable for the information marks on the optical disk. The track part 333 is controlled by the control signal from the signal transferor 31 to move the beam of the pick-up head 33 for tracking the orbit of the information marks. Thus, the focusing spot is for sure pointed toward the information marks. When the information marks reflects the beam projected from the pick-up head 33, the detector 334, such as an optical transducer, receives the reflections and transforms them into different electric signals based on the reflection flux received. Then, the electric signals are transmitted to the signal transferor 31.

The control system 30 of the disk device is connected with a host 40 outside the disk device. The host 40 includes a control unit 41, such as a highly efficient center processor unit (CPU). The control unit 41 can control the operation of the host 40, and can also decode the electric signals transmitted from the signal transferor 31 into an information signals. The information signals are decompressed to a video or audio specific format by a decompressed circuit 42, such as a MPEG interface. Meanwhile, based on of the speed of decoding and decompressing, or the demand of reading or writing the information data, the control unit 41 outputs control signals to the signal transferor 31. Then, the signal transferor 31 transfer the control signals to the apparatuses which need to be controlled. For example, the spindle motor 32 is controlled to rotate, the light source part 331 is controlled to radiate the beam, the focus part 332 is controlled to focus the beam, the track part 333 is controlled to enable the beam to track the orbit of the information marks, the pick-up head 33 is controlled to search the site of the information, and the detector 334 is controlled to achieve the electric signals. Then, the electric signals are transmitted back to the signal transferor 31, and output to the host 40 for decoding and decompressing.

Hence, the present invention integrates those servo units of the control system 30 into the highly efficient control unit 41 of the host 40. The disk device only remains the operation apparatuses, such as the spindle motor 32, the pick-up head 33, and the feeding mechanism 34, which is directly controlled by the control unit 41 of the host 40. Then, the disk device purely acts as the ignition, transfer, and transmission of control signals, and does not have the feature of various brands' control chips. Therefore, the disk device is compatible with any kind of hosts so as to extend adoptable range and increase the benefits of mass production.

Because the disk device, which leaves the function of its control system to the control unit of the host, just has operation apparatuses and the signal transferor 31, not only the disk device reduces the cost of the control component, but also simplifies the control of the disk device to lower the control complexity. Besides, due to curtailing the control component, the weight of the disk device also can be reduced, and increases the flexible usage inside the disk device. Furthermore, because the disk device is directly controlled outside, adding functions can easily be disposed in the host with a larger room to avoid the limitation of finite inner of the disk device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control system for a disk device connecting to a host which has a control unit to output control signals to the control system, comprising:
a signal transferor outputting information data to the control unit and transferring the control signals;
a spindle motor directly receiving the control signals from the signal transferor to control the rotation of a optical disc; and
a pick-up head directly receiving the control signals from the signal transferor to read data signals on the optical disk, and transmitting the data signals to the signal transferor.

2. The control system for a disk device of claim 1, further comprising a feeding mechanism which receives the control signals from the signal transferor to move the pick-up head back and forth along the radial of the optical disc.

3. The control system for a disk device of claim 1, wherein the pick-up head further comprises a light source part which receives the control signals from the signal transferor to radiate a beam.

4. The control system for a disk device of claim 3, wherein the light source part is a laser diode.

5. The control system for a disk device of claim 1, wherein the pick-up head further comprises a focus part which receives the control signals from the signal transferor to focus a focusing spot of the beam.

6. The control system for a disk device of claim 1, wherein the pick-up head further comprises a track part which receives the control signals from the signal transferor to move the beam for tracking an orbit of information data.

7. The control system for a disk device of claim 1, wherein the pick-up head further comprises a detector which receives the reflections of the optical disc, transforms the reflections into electric signals, and transmits the electric signals to the signal transferor.

8. The control system for a disk device of claim 1, wherein the control unit controls the operation of the host and outputs control signals to the signal transferor.

9. The control system for a disk device of claim 1, wherein the control unit decodes the information data from the signal transferor into a video or audio format.

10. The control system for a disk device of claim 1, wherein the signal transferor just outputs the information data and transfers the control signals without processing.
